(19) United States
(12) Patent Application Publication
(10) Pub. No.: US 2011/0204828 A1
(43) Pub. Date: Aug. 25, 2011

(54) LIGHT ASSEMBLY

(76) Inventors: Brett Robert Moody, Chicago, IL (US); Matthew Gerard Kowalec, Coto De Caza, CA (US); Alan Douglas Rushing, Irvine, CA (US)

(21) Appl. No.: 12/972,943

(22) Filed: Dec. 20, 2010

Related U.S. Application Data
(60) Provisional application No. 61/288,407, filed on Dec. 21, 2009.

(51) Int. Cl. H05B 37/02; F21L 4/00

(52) U.S. Cl. 315/360; 362/157

(57) ABSTRACT

A light assembly is provided with a housing with a first locking configuration. A light source is provided on the housing. A power source is provided on the housing for powering the light source. An interchangeable exterior shroud is sized to receive the housing and has a second locking configuration for locking the shroud to the housing such that the shroud provides an ornamental appearance of an exterior of a wax candle, and the light source provides an appearance of a flame.

### CROSS-REFERENCE TO RELATED APPLICATIONS

This application claims the benefit of U.S. provisional Application No. 61/288,407 filed Dec. 21, 2009; the disclosure of which is incorporated in its entirety by reference herein.

### TECHNICAL FIELD

Various embodiments relate to light assemblies.

### BRIEF DESCRIPTION OF THE DRAWINGS

FIG. 1 is a perspective view of a light assembly according to an embodiment of the invention;

FIG. 2 is another perspective view of the light assembly of FIG. 1;

FIG. 3 is a side elevation view of the light assembly of FIG. 1;

FIG. 4 is an axial section view of the light assembly of FIG. 1;

FIG. 5 is a bottom end view of the light assembly of FIG. 1;

FIG. 6 is a perspective section view of the light assembly of FIG. 1;

FIG. 7 is a perspective view of a bottom of the light assembly of FIG. 1, illustrated partially disassembled;

FIG. 8 is a perspective view of the light assembly of FIG. 1, illustrated partially disassembled;

FIG. 9 is a perspective view of the light assembly of FIG. 1, illustrated partially disassembled;

FIG. 10 is a side elevation view of the light assembly of FIG. 1, illustrated partially disassembled;

FIG. 11 is an end view of the light assembly of FIG. 1, illustrated partially disassembled;

FIG. 12 is another side elevation view of the light assembly of FIG. 1, illustrated partially disassembled;

FIG. 13 is an exploded perspective view of the light assembly of FIG. 1, illustrated partially disassembled;

FIG. 14 is an enlarged perspective view of a housing of the light assembly of FIG. 1;

FIG. 15 is an enlarged perspective view of an end of a shroud of the light assembly of FIG. 1;

FIG. 16 is an enlarged perspective view of a base of the housing of the light assembly of FIG. 1, illustrated partially disassembled.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

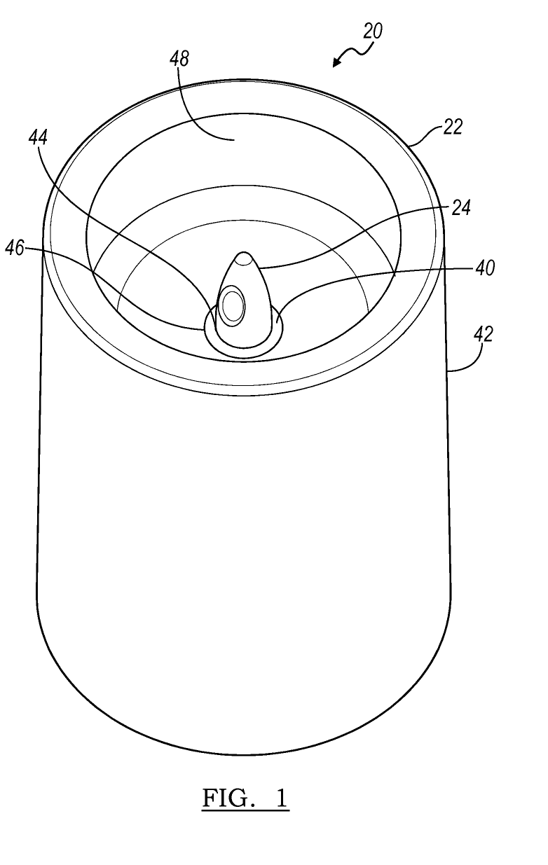

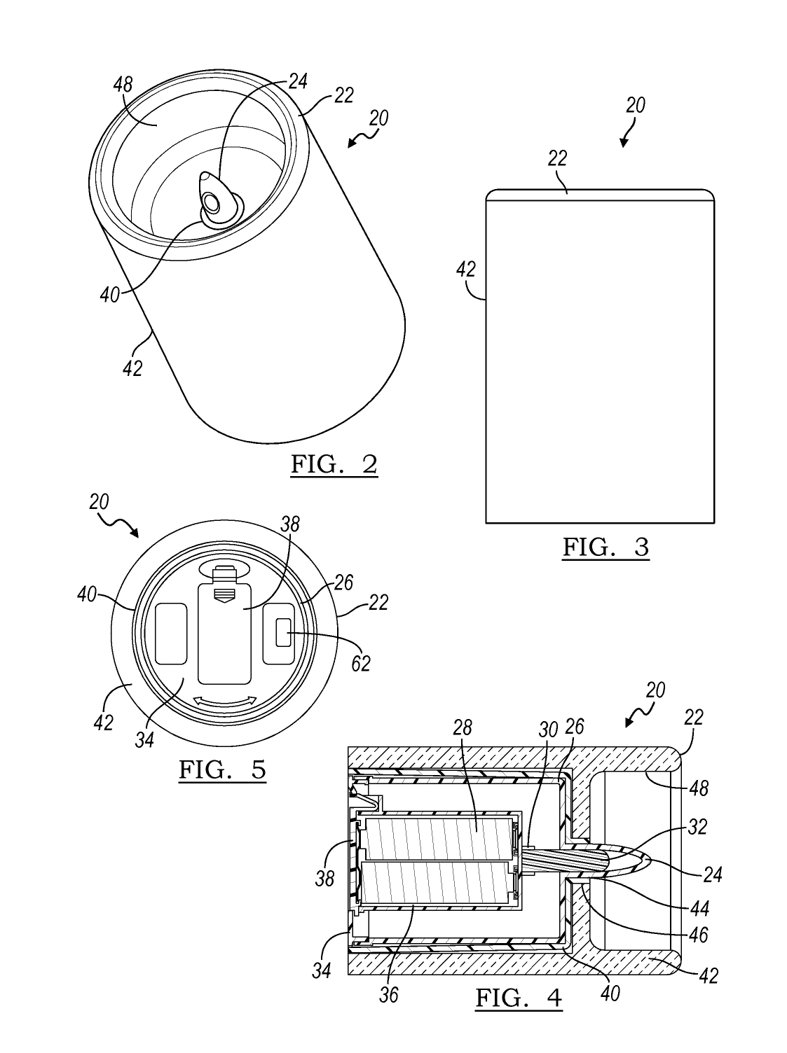

Referring now to FIGS. 1-3, a light assembly is illustrated and referenced generally by numeral 20. The light assembly 20 is depicted as an artificial or flameless candle. Flameless candles can simulate the many attributes of traditional burning candles, such as home decor, and can provide a source of illumination. One key attribute of conventional candles is fragrance dispersion. Many flameless candles are fabricated with candle wax shells. However, unlike a traditional candle that releases a fragrance due to the chemical operation provided by the flame at the wick, which burns the candle wax, a flameless candle has no mechanism of releasing any additional fragrance than that which is already exposed to the ambient environment from the surface of the candle shell, without an additional fragrance dispersion mechanism. While a flameless candle with a fragrant candle wax may initially provide an adequate fragrance, the scent will decay over time until the candle is functionally scentless. Further, both traditional candles and flameless candles are limited to the original shape, color, fragrance, or the like, of the original design.

The light assembly 20 includes an interchangeable exterior shroud 22, which is shaped to provide the ornamental appearance of an exterior of a wax candle and it conceals the remaining components of the light assembly 20, except for a lens 24. The lens 24 is generally tapered and is sized, shaped, and colored to provide an appearance of a flame upon a wick of a conventional wax candle. The shroud 22 that is depicted is only one example, and due to the interchangeability of the shroud 22, the shroud 22 may embody a variety of shapes, colors, fragrances, or the like.

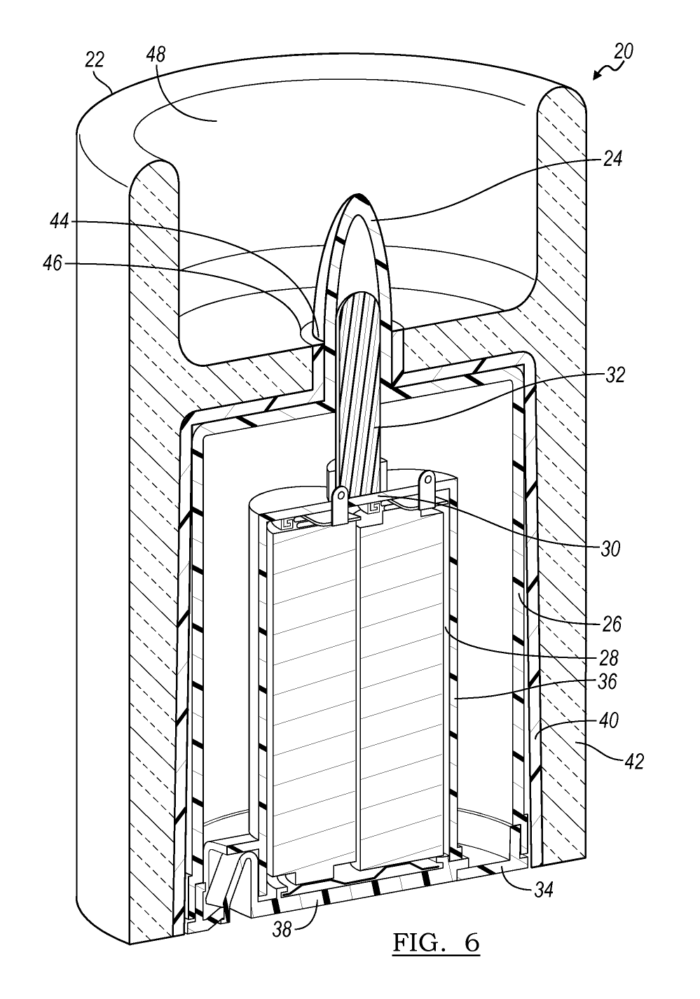

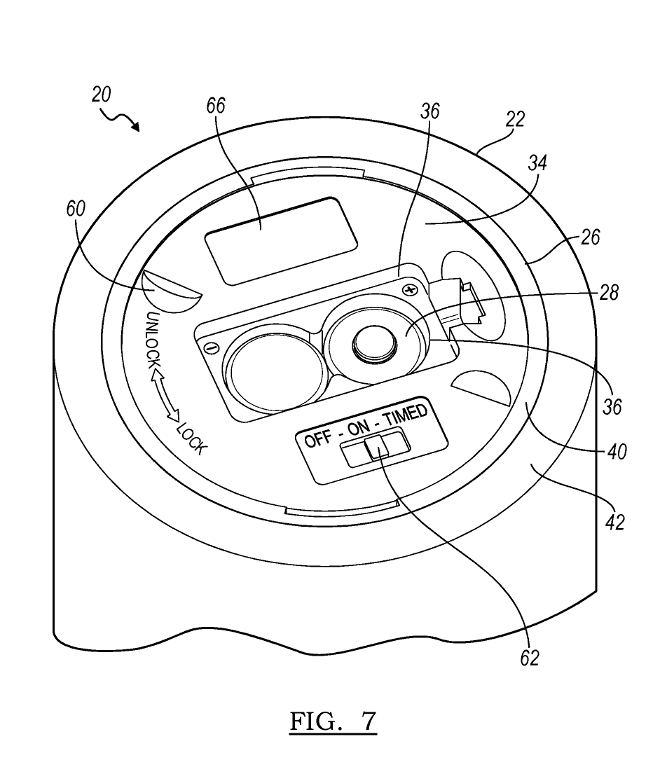

Referring now to FIGS. 4-7, the light assembly 20 is illustrated in greater detail. The light assembly 20 includes a housing 26. The housing 26 is generally frusto-conical in the depicted embodiment and is hollow for retaining components therein. The lens 24 extends from a closed end of the housing 26. A power source 28 is provided in the housing 26, which may be a pair of batteries 28 as depicted. Although batteries 28 are illustrated, the invention contemplates any power source, such as an electrical plug for receiving alternating current. A light source 30 may also be provided in the housing. The light source 30 may be any suitable light source, such as a light emitting diode (LED). A light pipe 32 may be utilized to convey light from the light source 30 into the lens 24. Although one LED 30 is depicted, the invention contemplates any number, or variation of lighting sources.

Referring specifically to FIG. 7, the housing 26 includes a base 34 with a battery compartment 36 recessed therein for receiving the batteries 28. Referring again to FIGS. 4-7, a door 38 may be provided over the battery compartment 36 for concealing and retaining the batteries 28 in the battery compartment 36.

The shroud 22 includes an internal shell 40 for mating with the housing 26. The shroud 22 also includes an external fragrant layer 42 that is formed about the shell 40, such as in a molding operation. Although separate layers are illustrated and described for the shell and fragrant layer 42, the invention contemplates that these components may be formed integrally for reducing parts. The shell 40 and the fragrant layer 42 include apertures 44, 46 for permitting the lens 24 and the light pipe 32 to extend therethrough for conveying the light within an upper cavity 48 and the fragrant layer 42.

Due to the volatile characteristic of fragrance, the fragrance of the fragrant layer 42 decays over time. Thus, when the period of decay of the fragrance of the fragrant layer 42 has expired, the shroud 22 may be disconnected from the housing 26 and replaced with a new shroud 22. The fragrant layer 42 of the shroud 22 may be constructed of paraffin wax, plastic, or the like. Additionally, the fragrant layer 42 of the shroud 22 may be constructed in a variety of shapes to permit the user to provide various decorative light assemblies 20. For example, the shroud 22 can be altered to match the home decor requirements of the user as needed, such as a traditional wax candle. Further, the light assembly 20 may employ interchangeable shrouds 22 for various decorative seasons, such as a snowman for winter, a jack-o-lantern at Halloween, or the like. Additionally, interchangeable shrouds 22 may be employed of varying fragrances so that the user may alter the fragrance as desired. The altered fragrance may also be seasonal, such as a pine-scented Christmas tree shaped shroud 22.

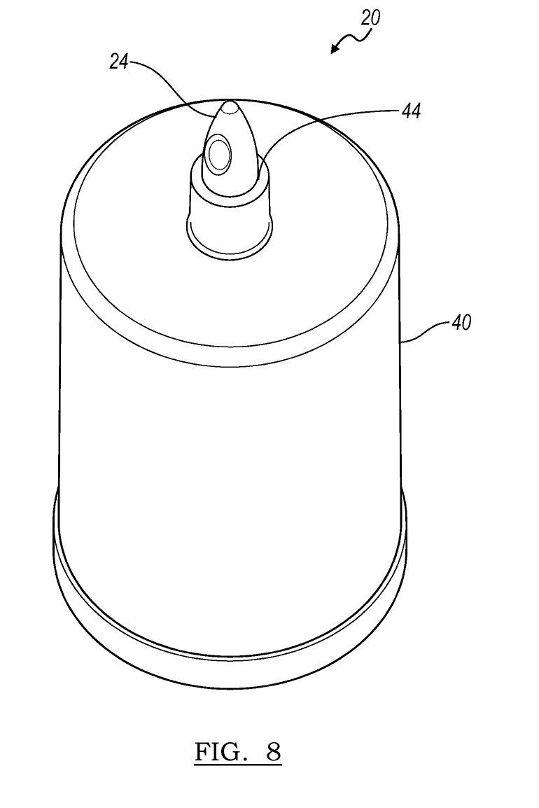

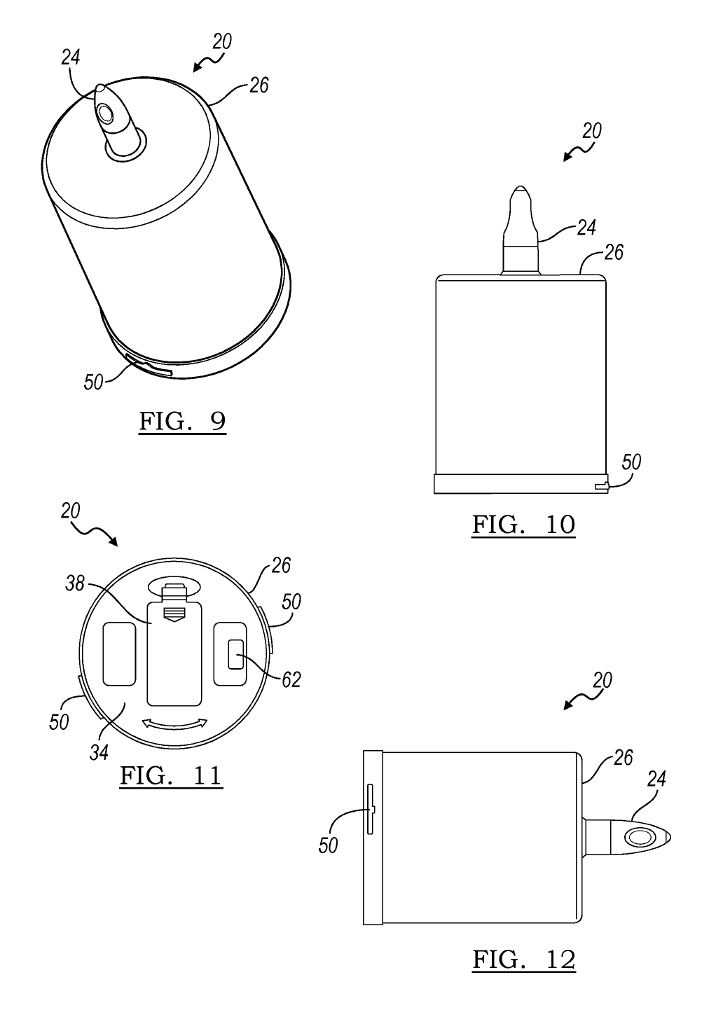

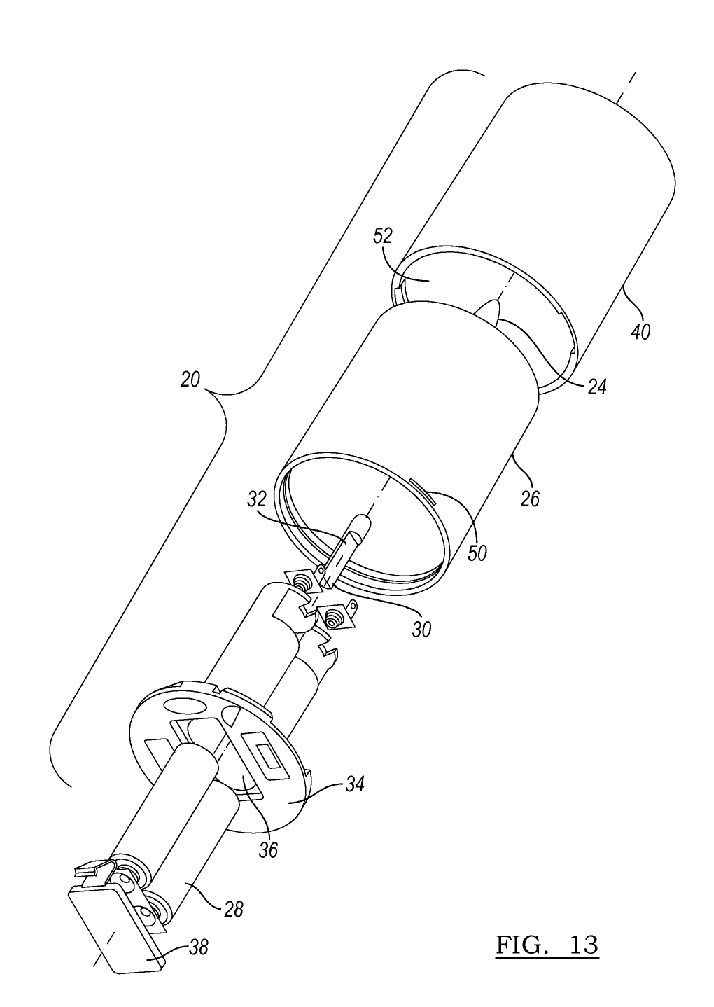

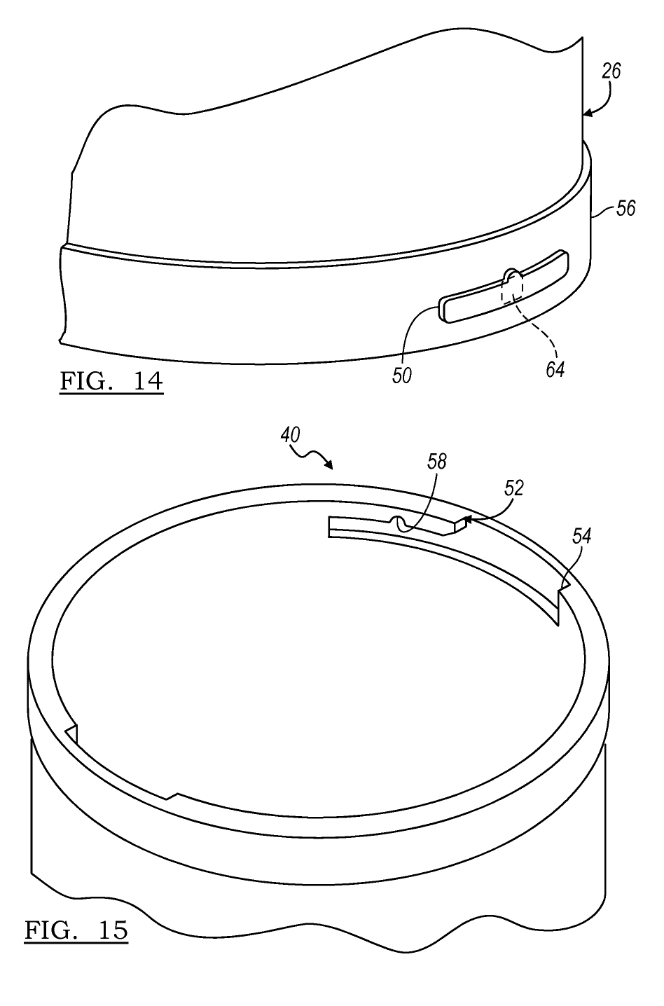

FIG. 8 illustrates the light assembly 20 with the fragrant layer 42 removed from the internal shell 40. FIGS. 9-12 depict the light assembly 20 without the shroud 22. The housing 26 includes a first locking configuration, such as a pair of bayonet lugs 50 extending radially outward from a lower periphery of the housing 26. One of the pair of bayonet lugs 50 is illustrated in enlarged detail in FIG. 14. The pair of bayonet lugs 50 are sized to be received in a corresponding pair of slots 52 provided in the shell 40 of the shroud 22 as illustrated in FIG. 15. The slots 52 include an opening 54 facing an outward axial direction of the shell 40 for receiving the bayonet lugs 50. The slots 52 extend circumferentially inward so that the bayonet lugs 50 can pass through the opening 54 and then, upon rotation of the shroud 22 relative to the housing 26, the bayonet lugs 50 are received at a region of the slots 52 offset from the openings 54 for retaining the shroud 22 upon the housing 26.

Referring again to FIG. 14, the bayonet lugs 50 may each include a projection 56 for being received in a corresponding recess 58 (FIG. 15) within the slot 52 for locking the shroud 22 in a secure rotary position relative to the housing 26 to provide a secured and assembled light assembly 20. Alternatively, a detent mechanism 56 may be provided for retracting into the bayonet lug 50 during travel within the slot 52 and extending into the recess 58. Referring again to FIG. 7, the base 34 may include a pair of finger wells 60 for permitting a user to grip the base 34 for rotating the housing 26 relative to the shroud 22.

Although a pair of bayonet lugs 50 and a pair of corresponding slots 52 are illustrated and described, the invention contemplates any number of lugs 50 and slots 52. The lugs 50 and slots 52 are illustrated as an example of a pair of corresponding locking configurations. Of course, any locking configuration is contemplated, such as a threaded engagement, a press fit engagement, or the like.

Also illustrated in FIG. 7, is a switch 62, which is hidden when the light assembly is resting upon the base 34. The switch 62 permits the user to turn the light assembly off, on, or to a timed period, which may be predetermined or user selected. Alternatively, the shroud 22 may include a capacitive touch sensor in electrical communication with the housing 26 so that the light assembly 20 may be turned on or off by an external touching by the user to the exterior of the shroud 22.

Referring again to FIG. 14, the projection 56 may be a detent that actuates a switch 64 within the housing 26. The switch 64 is in electrical communication with a controller 66 (FIG. 7) in the housing 26. Actuation of the switch 64 occurs during assembly of a new shroud 22 upon the housing 26. The actuated switch 64 sends a signal to the controller 66 for informing the controller 66 that a new shroud 22 has been assembled to the housing 26. Accordingly, the controller 66 begins a countdown with a timer for a predetermined amount of time that corresponds to a period of decay of the fragrance of the shroud 22. Upon completion of the countdown by the timer, the controller 66, which also controls the lighting from the light source 30, provides a display for the light source 30 for indicating to the user that the period of fragrance of the shroud 22 is expired. The display may be provided by blinking the light source 30, or the like, for indicating that the fragrance has dissipated. Accordingly, the user may be warned, or reminded, to replace the shroud 22.

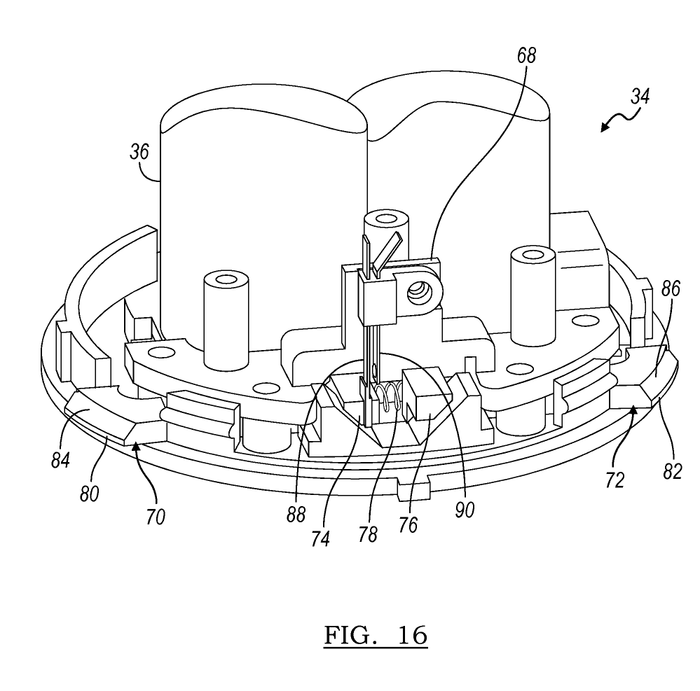

FIG. 16 illustrates the base 34 partially disassembled without the housing 26 for illustrating a switch assembly 68 according to another embodiment. The switch assembly 68 is mounted to an inboard side of the base 34 and is oriented with the housing 26. The switch assembly 68 includes a pair of linear slide bars 70, 72 mounted to the base and constrained for sliding linearly inboard and outboard. Each of slide bars 70, 72 includes a proximal end 74, 76 that terminate spaced apart from one another. A coil spring 78 is oriented between the proximal ends 74, 76 of the slide bars 70, 72 to extend distal ends 80, 82 of the slide bars 70, 72 outboard in an unloaded, or disassembled condition. The distal ends 80, 82 of the slide bars 70, 72 extend through apertures (not shown) in the housing 26 to extend to positions that intersects with an inner diameter of the internal shell 40. Additionally, each of the distal ends 80, 82 of the slide bars 70, 72 include a tapered surface 84, 86.

During assembly of the housing 26 into the shroud 22, the tapered surfaces 84, 86 of the slide bars 70, 72 contact an inner diameter of the internal shell 40 of the shroud 22. As the housing 26 is inserted into the shroud 22, the tapered surfaces 84, 86 cause the distal ends 80, 82 of the slide bars 70, 72 to slide inboard, thereby retracting the distal ends 80, 82 of the slide bars 70, 72 relative to the housing 26. The proximal end 74 of one of the slide bars 70 is connected to a contact 88 of the switch assembly 68. As the slide bar 70 is retracted, the contact 88 is flexed into electrical engagement with another contact 90 of the switch assembly 68. The engagement of the pair of contacts 88, 90 closes the switch 68, thereby indicating to the controller 66 that the circuit is closed, and that the shroud 22 has been assembled to the housing 26. This signal permits the controller 66 to begin the timer associated with the period of decay of the fragrance of the shroud 22. Upon disassembly of the shroud 22 from the housing 26, the slide bars 70, 72 extend thereby disengaging the flexed contact 88 from the other contact 90, which reopens the switch 68. Likewise, once another shroud 22 is assembled to the housing 26, the switch 68 is closed again, indicating the addition of a new shroud 22.

At least one embodiment provides a light assembly comprising: a housing having a first locking configuration; a light source provided on the housing; a power source provided on the housing for powering the light source; and an interchangeable exterior shroud being sized to receive the housing, the shroud having a second locking configuration for engaging the first locking configuration for locking the shroud to the housing such that the shroud provides an ornamental appearance of an exterior of a wax candle, and the light source provides an appearance of a flame.

At least one further embodiment provides the shroud with a decayable fragrance.

At least an even further embodiment further comprises: a switch on the housing for cooperating with the shroud for conveying a signal that a shroud has been locked to the housing; and a controller in the housing in electrical communication with the switch and the light source for receiving the signal from the switch, beginning a timer for a predetermined amount of time corresponding to a period of decay of the fragrance, and controlling the light source to provide a display to indicate that the fragrance has decayed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A light assembly comprising:
a housing having a first locking configuration;
a light source provided on the housing;
a power source provided on the housing for powering the light source; and
an interchangeable exterior shroud being sized to receive the housing, the shroud having a second locking configuration for engaging the first locking configuration for locking the shroud to the housing such that the shroud provides an ornamental appearance of an exterior of a wax candle, and the light source provides an appearance of a flame.

2. The light assembly of claim 1 wherein the shroud is provided with a decayable fragrance.

3. The light assembly of claim 2 further comprising a switch on the housing for cooperating with the shroud for conveying a signal that a shroud has been locked to the housing.

4. The light assembly of claim 3 further comprising a controller in the housing in electrical communication with the switch and the light source for receiving the signal from the switch, beginning a timer for a predetermined amount of time corresponding to a period of decay of the fragrance, and controlling the light source to provide a display to indicate that the fragrance has decayed.

5. The light assembly of claim 3 wherein the switch comprises:
a pair of linear slide bars mounted to the housing;
a biasing member for extending the slide bars; and
a pair of electrical contacts provided on proximal ends of each of the pair of slide bars such that assembly of the housing into the shroud retracts the slide bars and closes the pair of electrical contacts.

6. The light assembly of claim 1 further comprising a lens extending from the housing through an aperture in the shroud, the lens cooperating with the light source for conveying light from the light source and through the shroud.

7. The light assembly of claim 6 wherein the lens is tapered.

8. The light assembly of claim 6 wherein the lens is hollow; and
wherein the light assembly further comprises a light pipe extending from the light source and within the lens for conveying the light through the lens.

9. The light assembly of claim 1 wherein the light source comprises a light emitting diode.

10. The light assembly of claim 1 wherein the exterior shroud comprises an internal shell and an external fragrant layer.

11. The light assembly of claim 10 wherein the external fragrant layer comprises wax.

12. The light assembly of claim 10 wherein the second locking configuration is provided on the internal shell.

13. The light assembly of claim 1 wherein the first locking configuration comprises at least one bayonet lug.

14. The light assembly of claim 13 wherein the second locking configuration comprises at least one slot.

15. The light assembly of claim 14 further comprising a projection provided on the at least one bayonet lug.

16. The light assembly of claim 15 wherein a recess is formed in the slot for receiving the projection for securing a rotary position of the shroud relative to the housing.

17. The light assembly of claim 16 further comprising a detent provided on the at least one bayonet lug for retracting the projection during assembly, and extending the projection into recess.

18. The light assembly of claim 1 wherein the housing comprises a base with a pair of finger wells formed therein for permitting a user to grip the base and rotate the housing relative to the shroud.

19. A light assembly comprising:
a housing having a first locking configuration;
a light source provided on the housing;
a power source provided on the housing for powering the light source; and
an interchangeable exterior shroud being sized to receive the housing, the shroud having a second locking configuration for engaging the first locking configuration for locking the shroud to the housing, the shroud being provided with a decayable fragrance.

20. A light assembly comprising:
a housing;
a light source provided on the housing;
a power source provided on the housing for powering the light source;
an interchangeable exterior shroud being sized to receive the housing, the shroud being provided with a decayable fragrance;
a switch on the housing for cooperating with the shroud for conveying a signal that a shroud has been assembled to the housing; and
a controller in the housing in electrical communication with the switch and the light source for receiving the signal from the switch, beginning a timer for a predetermined amount of time corresponding to a period of decay of the fragrance, and controlling the light source to provide a display to indicate that the fragrance has decayed.
